(19) United States
(12) Patent Application Publication
(10) Pub. No.: US 2013/0244229 A1
(43) Pub. Date: Sep. 19, 2013

(54) BUFFERING COMPOSITIONS ENCLOSED IN A SIZE EXCLUSION MATRIX

(71) Applicants: Jan Bergstrom, Balinge (SE); Bo-Lennart Johansson, Uppsala (SE)

(72) Inventors: Jan Bergstrom, Balinge (SE); Bo-Lennart Johansson, Uppsala (SE)

(21) Appl. No.: 13/990,765

(22) PCT Filed: Nov. 29, 2011
(86) PCT No.: PCT/SE2011/051439

§ 371 Date: May 30, 2013

(30) Foreign Application Priority Data
Nov. 30, 2010 (SE) 1051266-3

(51) Int. Cl. G01N 1/28

(52) U.S. Cl. CPC G01N 1/28
USPC 435/5; 435/29; 436/176

(57) ABSTRACT

The present invention relates to a buffering composition, more closely a composition comprising porous matrix-enclosed buffering agent(s) giving a stabilisation of pH when applied in for example aqueous environment.

The composition comprises buffering agent(s) enclosed in a first porous matrix with an impenetrability corresponding to a fractionation range for globular proteins and peptides of <10000 g/mol, preferably <5000 g/mol, more preferably <700 g/mol.

### FIELD OF THE INVENTION

The present invention relates to a buffering composition, more closely a composition comprising porous matrix-enclosed buffering agent(s) giving a stabilisation of pH when applied in for example aqueous environment.

### BACKGROUND OF THE INVENTION

Buffer solutions are used as a means of keeping pH at a nearly constant value in a wide variety of chemical applications. Traditional buffers means that the buffer components are dissolved in the sample solution and consequently “contaminate” the sample solution. A buffer solution is conventionally an aqueous solution consisting of a mixture of a weak acid and its conjugated base or a weak base and its conjugated acid.

pH of buffer compound solutions changes very little around the pKa of the buffer agent when a small amount of strong acid or base is added to it.

Buffered compositions of bio-organic substances are needed in many cases where a bio-organic substance is to be further processed. Especially in cases where the molecular charge distribution has to be well defined as e.g. in ion exchange chromatography of proteins or for stabilization of a biomolecule solution or formulation.

As soon as a bio-molecule, such as e.g. a protein, has been titrated to a certain pH and consequently a certain charge distribution there is in many cases no longer any need to have any buffering compounds present in the bio-molecule solution unless other operations introduces hydrogen or hydroxyl ions.

Thus, there is a need of alternative buffering compositions.

### SUMMARY OF THE INVENTION

The present invention provides a composition comprising buffering agent(s) enclosed in a first porous matrix with a pore size distribution corresponding to a fractionation range for globular proteins and peptides of <10000 g/mol g/mol, preferably <5000 g/mol, more preferably <700. The composition has buffering capacity in aqueous solutions, mixtures of water and organic solutions and in organic solutions only, such as alcohols, acids and amines.

In one embodiment only the outer surface layer of the first matrix shows said density, i.e. is a semi penetrable part that allows penetration of small ions but prevents other unwanted or disturbing interactions with and access to its internal parts which contain suitable buffering agent(s).

In an alternative embodiment the composition is partly enclosed by said matrix and partly by a surface on which it is provided, see FIG. 2.

In a further embodiment the buffering agents are shielded with polymers or other large molecules (FIG. 3), such as e.g. dextran, polyethylene glycol, dextrin.

In yet a further embodiment the first matrix is enclosed in at least one (or more) further porous matrices. Examples of this is shown in FIG. 4A-C where the first matrix is enclosed in a second matrix.

Preferably, the composition is in the form of sheets, gel slabs, nets, threads, cubes, beads or scaffolds.

The matrix (matrices) is/are selected from any synthetic, natural organic and inorganic polymeric or polymer like base matrices.

The buffering agents are selected from buffering agents in acid- and/or base form, monomers as well as polymers, large and small molecules, charged or un-charged. The buffering agents may be covalently bound to the matrix. In another alternative, the buffering agents are bound to a polymer which is also enclosed (trapped, i.e. is not able to get through the less porous outer part of the matrix) within said matrix.

In one embodiment, the porous matrix is provided with ligands for binding of and interaction with sample molecules or microbiological particles as virus and cells in the outer surface layer, i.e. the surface which will be in contact with the sample molecules. Applications for this embodiment are for example IEX, HIC, RPC, affinity, and ligands enhancing cell growth

Thus in one embodiment, the invention relates to a composition according to one or more of the above claims, wherein the matrix, or at least the outer part thereof, is provided as a microcarrier for cell cultivation, and wherein the microcarrier is provided with a built in buffer system.

The buffering agents are selected from nitrogen containing compounds having a free electron par able to form a reversible bond to a hydrogen atom, carboxyl and phosphonate containing functionalities together with di, tri, tetra, up to polymeric functional groups containing the above mentioned functional groups e.g graft polymerized polyacrylic acid, polyvinylphosphate or zwitter ionic ligands also containing the mentioned functional groups.

The composition is preferably in dried, re-swellable form and provided with a weak salt solution. The swelled compositions, such as beads, may be delivered with some salt dissolved in the slurry and/or a weak salt solution may be washed into the compositions to be dried. The amount of salt should be sufficient enough for starting the ion transport and thus pH-stabilisation without the need of adding extra salt before use.

In another embodiment, the composition is provided with magnetic particles inside the matrix.

The composition may have a high resulting density compared to water solutions resulting from its own high density (heavy) matrix or from heavy particles embedded inside the matrix enhancing the sedimentation, one example is shown in FIG. 5.

The composition may also have a low resulting density compared to water solutions enhancing removal by flotation or skimming.

In one embodiment, the composition is provided on a stick, pipette, chip, tube, sheet, membrane, gel slab, in a “tea bag”.

Furthermore, the invention provides a method for pH adjustment or pH-stabilisation of a solution, comprising adding or exposure of the solution to one or more of the above compositions said solution

A method for counter ion exchange of a solution is also provided, comprising adding one or more of the above compositions saturated with the counter ion to be introduced to said solution

The invention may also be used in a method for adjustment of the net charge of molecules in a solution comprising adding one or more of the above compositions said solution.

Another possibility is a method for adjustment of the net charge of biomolecules, such as peptides, proteins, nucleic acids, cells or portions thereof, cell fragments, virus or portions thereof, viral particles, in order to reduce the need for dissolved buffer substances in a chromatographic method.

The invention also provides a method for titration and changing pH of a solution, comprising adding one or more of the above compositions where the buffering agents are substituted by quaternary amines or strong acid entities in hydroxide or protonized form.

By the term buffering composition in the context of the invention is meant matrix-enclosed buffer systems that easily can be removed from the sample solution after the pH of the solution has been adjusted. The matrix-enclosed buffer system is also designed not to allow the buffering component to interact with large sample molecules as e.g. large bio-organic substances, but allow small ion exchange between the buffer region of the buffer system and the surrounding solution

The buffering composition according to the invention may for example be used within the following areas:

a) Protein formulation technology which is an integral part of drug development. The active ingredients such as a protein must be stable over the shelf life of the product. It may be possible to modify the shelf life significantly when a change to the active buffer ingredient is made. Buffer components added to protein solutions may degrade proteins upon storage by aggregation, oxidation, or deamidation mechanisms.

Porous matrix-enclosed buffering agent(s) can replace traditional buffer adjustments in many cases and make it possible to avoid adding buffer compounds to the formulation that later may have unwanted effects for its use and increase the life time of protein solutions by preventing bacterial and mould growth and protein denaturation. For example during freezing in buffers, selective precipitation of a less soluble buffer component and subsequent pH shifts may induce protein denaturation.

Several traditional buffer solutions, as such, usually suffer from contamination due to microorganism growth after a few days storage at room temperature and even at 4-8 C in a refrigerator.

(b) pH-adjustment with the buffing composition of the invention may be of advantage when structural biological laboratories study the relationship between the function, structure and dynamics of proteins. When traditional buffers are used one always will have some buffer components bound as counter ions to charged functional groups together with the main salt ions in the biomolecules used in the study. This may, to a different degree depending on which type of buffering agent that is used, have an effect the 3D structure of studied bio-molecules

(c) Analytical methods used for bio-organic substances which may be disturbed by the presence of buffer components leading to inaccurate results. Typical examples are mass spectrometry, elemental analysis, etc. In analytical application involving mass spectrometry buffer compounds may interact in a way that are unwanted and introduces a serious complication of the analytical procedure. SPR detection methods are by nature sensitive to very small changes in buffer salt composition and concentration.

(d) Buffering is also often an important and necessary process in the manufacturing of bio-organic substances of pharmaceutically acceptable purity and/or of purity acceptable for the food industry;

(e) Chromatographic methods based on the use of buffer components hidden in solid structures (buffer beads) for adjusting the net charge of bio-organic substances in order to reduce or avoid the need for dissolved buffer substances especially in industrial large scale applications;

(f) Lowering buffer related costs since buffer compounds are in many cases expensive chemicals. The invention may reduce cost and simplify industrial processes involving high volumes of buffer solutions

(g) The making, handling and storing of buffer solutions in large scale are costly. It is also often necessary to have a costly extra process step to remove buffer agents from a sample solution or a medical formulation.

(h) Reduction of negative side effects caused by buffer compounds such as extra adsorption and base line drifts even for common UV detection.

(i) Microcarriers for cell culture with built-in buffering properties for pH stabilisation during cell growth in order to avoid the addition of soluble buffer substances/agents and provide excellent opportunities for the control of pH at the adsorption sites of the cells.

### BRIEF DESCRIPTION OF THE DRAWINGS

FIG. 1 shows a schematic view of buffering compositions/beads according to the invention.

FIG. 2 shows a buffering composition provided on a surface;

FIG. 3 shows buffering agents on a surface shielded with polymers also provided on the surface;

FIG. 4 A-C show different embodiments of buffering compositions enclosed in porous matrix beads which in turn are enclosed in a further porous matrix that prevents unwanted close contacts and interactions between the embedded buffering entities and large molecules in the sample;

FIG. 5 shows a schematic view of buffering composition/bead with a embedded heavy or light particle or solid non-porous core and an empty (no matrix) core; and

FIG. 6 shows a schematic view with buffering ligands attached in pores not available for large molecules defined in claim 1.

### DETAILED DESCRIPTION OF THE INVENTION

This invention is in one preferred type of design based on entities with an outer semi penetrable part that allows penetration of small ions but prevent other unwanted or disturbing interactions with and access to their internal parts, which contain suitable buffering agent as e.g. beads with buffering agents preferable attached or enclosed in the core shielded by the outer membrane like structure. In another preferred general type of design of the entities contains buffer agent embedded in large shielding molecules such as e.g. dextrans, polyethylene glycol (PEG), and other oligomeric or polymeric compounds. that prevents unwanted interaction with the sample but allows small ions to reach the buffer agent.

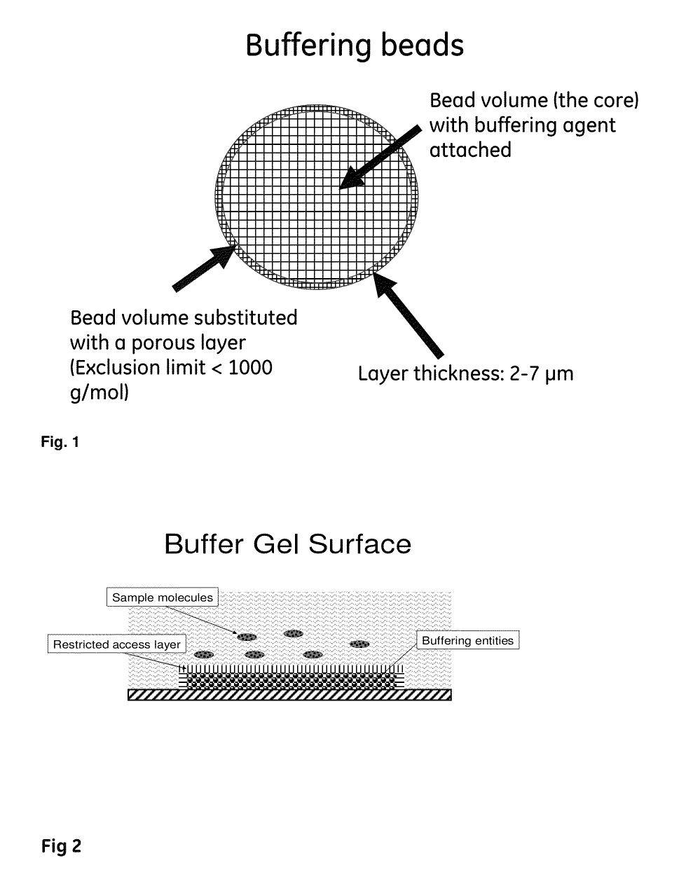

The entities/beads are aimed as solid phase buffer for biomolecule solutions or other solutions in which a stabilisation of pH is of importance. Beads for use as solid phase buffers can be designed as depicted in FIG. 1. The advantage with using beads as a buffering system is that the sample can easily be separated from the buffer by e.g. a. filtration step and the sample will not be contaminated with the buffering substance. The beads can also easily be regenerated and used repeatedly. Before use, the buffer agents in the buffering beads are equilibrated or titrated to a suitable pH (which are depending on the pKa of the core ligand) and then washed preferable with pure water for use as they are or dried. Dried agarose beads will easily swell when added to the sample solution and the pH of the sample solution will quickly be adjusted. The solution has to contain a small amount of ions e.g. sodium chloride in order to mediate and facilitate the equilibration process leading to the pH adjustment the solution. The protein/peptide solution will not be contaminated by buffer components and the construction of the beads (FIG. 1) will prevent the proteins and peptides to diffuse into the core of the buffering beads and interact with the attached buffer ligands. It is also highly suitable to make the buffering beads magnetic, “heavy” (fast sedimenting) or floating for simple removal from the sample solution.

Buffering entities in different formats may be considered e.g. a porous polymeric layer containing buffering entities having a semi penetrable outer layer (as described above) that allows penetration of small ions but prevent other unwanted or disturbing interactions with and access to its internal parts attached on a solid surface as shown in FIG. 2. This is a format that may be used on sensor surfaces and inside test tubes, test sticks, pipette tips, sheets, membranes, gels slabs, tea bags etc.

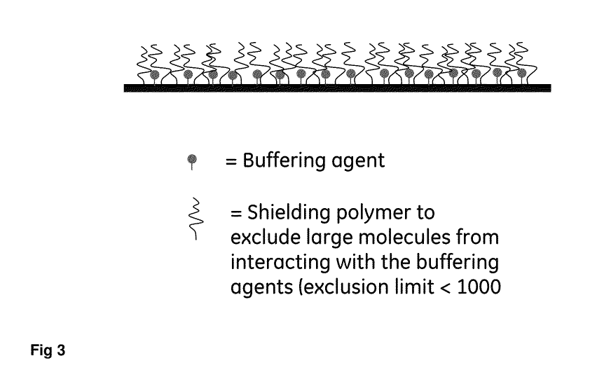

Buffering sheets, gel slabs, nets, threads, cubes, beads, scaffolds made up of different types of flexible and rigid porous materials having an outer small pore surface layer or a steric shielding of the buffering functionalities prohibiting the sample molecules to come in contact and interact with the internal buffering entities is shown in FIG. 3.

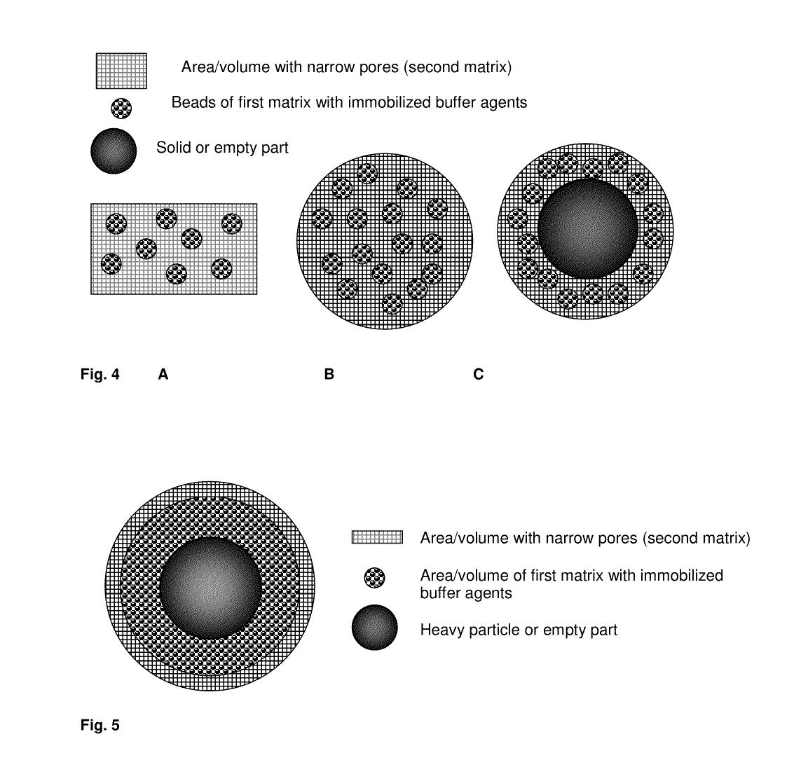

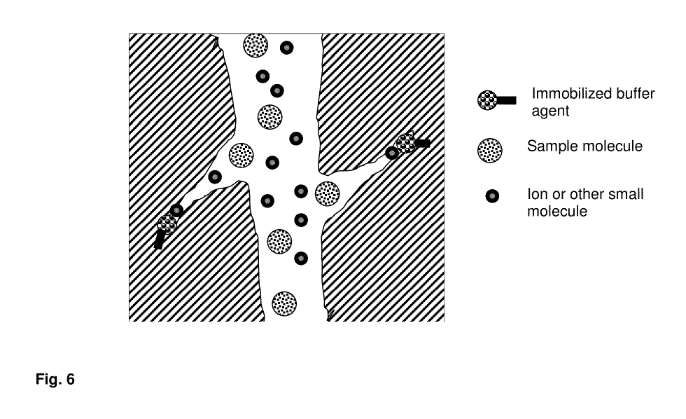

In a further type of general design buffer containing porous particles is embedded in at least one secondary small pore matrixes (FIG. 4 A-C) that only allows passages of small ions and molecules analogous with the above mentioned designs.

Another not shown alternative is buffering compositions, such as buffer beads, provided in tea bag-format and other analogue formats for simple addition and removal.

### EXPERIMENTAL PART

The present examples are provided for illustrative purposes only, and should not be construed as limiting the scope of the present invention as defined by the appended claims.

### Preparation of Buffer Media Based on Dextran Shell Magnetic Sepharose Beads with Tris (Tris (Hydroxymethyl) Aminomethane) Ligands Attached in the Core of the Beads

Volumes of matrix refer to settled (vacuum drained) bed volume.

Weights of matrix given in gram refer to suction dry weight (drained gel). It is understood that these matrices are still water solvated material. Reaction stirring refers to a suspended, motor-driven stirrer since the use of magnet bar stirrer is prompt to damage the beads. Conventional methods were used for the analysis of the functionality and the determination of the degree of allylation and the degree of substitution of ion exchanger groups on the beads. The TRIS prototype was prepared starting from magnetic cross linked agarose beads (Sepharose Mag) with a bead size of 97 μm (GE Healthcare, Uppsala, Sweden).

Preparation of 4 μm Thick Dextran Shell Sepharose Mau with Tris Ligands Attached in the Core of the Beads

### Preparation of Dextran Shell Sepharose Mag

Allyl activated Sepharose Mag. 17 mL of drained Sepharose Mag (agarose beads containing small magnetic particles) was transferred to a reaction vessel and mixed with 2 mL water, 3.5 mL of 50% NaOH solution and 2 g Na₂SO₄. The mixture was stirred at 50° C. for 30 minutes, followed by addition of 5 mL allyl glycidyl ether (AGE). The reaction slurry was stirred at 50° C. for 18 h. The gel was then washed on a glass filter with distilled water, ethanol and finally with distilled water again. The allyl content was 283 μmol/mL (measured by titration).

Partial bromination (4 μm shell activation). 17 g of drained allylated Sepharose Mag (corresponding to a total of 4.8 mmol allyl groups) and 2 g sodium acetate were stirred in 200 mL of distilled water. 62 μL of bromine (corresponding to 0.25 equivalents of allyl groups) was dissolved in 110 mL distilled water in a well closed glass container. The bromine solution was added to the gel solution in 5 portions during 2 minutes. After 5 minutes stirring the gel was washed on a glass filter with distilled water.

Dextran coupling. 17 g of drained partially brominated Sepharose Mag was transferred to a flask, and a solution of 10.5 g Dextran AB in 12 mL of distilled water was added. After stirring for 1 h, 2 mL of 50% NaOH solution and 0.2 g NaBH₄ were added and the slurry was heated to 50° C. and left stirring over night. After approximately 18 hours the pH was adjusted to approximately 7 with acetic acid (60% solution). The gel was then washed with distilled water on a glass filter.

### Core Coupling of Tris

Coupling of Tris in the core of the beads. 8.5 g of drained shell dextran Sepharose Mag gel (see above) and 1 g of sodium acetate were stirred in 10 mL of distilled water. Bromine (saturated aqueous solution) was added to a persistent yellow colour was obtained, followed by destruction of excess bromine with sodium-formiate and washings with distilled water. 8.5 g of drained brominated gel was stirred, in a solution of 1.5 g of Tris in 7 mL of distilled water (adjusted to pH 12.8 with 50% NaOH solution) at 50° C. for 17 h. The gel was then washed on a glass filter funnel with distilled water.

The core ligand density was estimated by determining the Cl⁻ capacity: 163 μmol/mL drained gel.

### Evaluation of Magnetic Buffer Beads with Tris Attached in the Core of the Beads

The magnetic buffer beads based on Sepharose Mag beads (see synthesis procedure above) were constructed with a gel filtration shell for exclusion of large proteins and with Tris buffer ligands attached in the core of the beads. The exclusion limit of the shell can easily be adjusted by for example changing the size of the polymer attached in the shell or increasing the amount of polymer coupled in the shell. For this prototype (Mag-Tris) the shell porosity was designed for exclusion of human IgG. It is of course also possible to use beads having a pore size distribution that from the start in principal only allows salt ions to pass and using the shell forming technique described elsewhere in order to make the outer part of the beads non-interacting and the core functionalized with buffering ligands.

### Results and Discussion

The Mag-Tris prototype was equilibrated with 1 M NaOH solution and then washed with distilled water, ethanol and finally dried at 90° C. in a vacuum drying cabinet. This means that the Tris ligands in the core of the beads are uncharged. It is well known that acid-base titration of weak ion exchangers are affected by many experimental variables such as salt concentration of titrand, swelling of the gel, volume of solvent in which the titration is carried out and the time used for titration. In addition, the same ligand (e.g. Tris) has different pKa-values depending where in the bead the ligand is attached. According to titration curves the pKa of Tris attached to Sepharose media has an apparent pKa of approximately 6. To test the Mag-Tris prototype 340 mg dried prototype (see above) were added to 10 mL of a water solution containing 3 mg IgG/mL (human immunoglobulin, Gammanorm) and 0.2 M NaCl. The pH of the IgG solution was 4.8 and after addition of 340 mg dried Mag-Tris the pH was quickly adjusted to 8.3. After the removal of the magnetic beads from the solution with a magnet the pH of the IgG solution was stable at 8.3 by aid of the buffering functional groups of the sample molecules.

In order to test that IgG not was adsorbed to the Mag-Tris beads the UV-signal (280 nm) was measured before and after the addition of the beads. The solution was diluted 5 times and the absorbance at 280 nm was determined to 0.78 AU in the untreated IgG solution and 0.81 in the Mag-Tris treated solution. The results clearly indicate that Mag-Tris beads do not interact with IgG.

1. A composition comprising buffering agent(s) enclosed in a first porous matrix with a impenetrability corresponding to a fractionation range for globular proteins and peptides of <10000 g/mol, preferably <5000 g/mol, more preferably <700 g/mol.

2. The composition of claim 1, wherein at least the outer surface layer of the first matrix shows said impenetrability.

3. The composition of claim 1, wherein the composition is partly enclosed by said matrix and partly by a surface on which it is provided.

4. The composition of claim 1, wherein the buffering agents are shielded with polymers or other large molecules, such as dextran, agarose, polyethylene glycol, dextrin.

5. The composition of claim 1, wherein the first matrix is enclosed in at least one (or more) further porous matrices.

6. The composition of claim 1, wherein the composition is in the form of sheets, gel slabs, nets, threads, cubes, beads or scaffolds.

7. The composition of claim 1, wherein the matrix is selected from synthetic, natural organic and inorganic polymeric or polymer like base matrices.

8. The composition of claim 1, wherein the buffering agents are selected from buffering agents in acid- and/or base form, monomers as well as polymers, large and small molecules, charged or un-charged.

9. The composition of claim 1, wherein the buffering agents are covalently bound to the matrix.

10. The composition of claim 1, wherein the buffering agents are bound to a polymer which is also enclosed (trapped, i.e. is not able to get through the less porous outer part of the matrix) within said matrix.

11. The composition of claim 1, wherein the porous matrix is provided with ligands for binding of and interaction with sample molecules or microbiological particles as virus and cells in the outer surface layer, i.e. the surface which will be in contact with the sample molecules.

12. The composition of claim 1, which is provided as a microcarrier for cell cultivation, wherein the matrix, or at least the outer part thereof is functionalized for promoting and supporting cell adhesion and cell growth, and wherein the microcarrier is provided with a built in buffer system.

13. The composition of claim 1, wherein the buffering agents are selected from nitrogen containing compounds having a free electron par able to form a reversible bond to a hydrogen atom, carboxyl and phosphonate containing functionalities together with di, tri, tetra, up to polymeric functional groups containing the above mentioned functional groups e.g graft polymerized polyacrylic acid, polyvinylphosphate or zwitter ionic ligands also containing the mentioned functional groups.

14. The composition of claim 1, wherein the composition is in dried, re-swellable form.

15. The composition of claim 14, which is provided with a small-amount of free soluble salt.

16. The composition of claim 1, wherein the composition is provided with magnetic particles inside the matrix.

17. The composition of claim 1, wherein the composition has a high resulting density compared to water solutions resulting from its own high density (heavy) matrix or from heavy particles embedded inside the matrix enhancing the sedimentation.

18. The composition of claim 1, wherein the composition has a low resulting density compared to water solutions enhancing removal by flotation or skimming

19. The composition of claim 1, wherein the composition is provided on a stick, pipette, chip, tube, sheet, membrane, gel slab, in a “tea bag”.

20. The composition of claim 1, wherein buffering ligands are attached in pores not available for large molecules defined in claim 1.

21. A method for pH adjustment or pH-stabilisation of a solution, comprising adding or exposure of the solution to one or more of the compositions of claim 1 to said solution.

22. A method for counter ion exchange of a solution, comprising adding one or more of the compositions saturated with the counter ion to be introduced according to claim 1 to said solution.

23. A method for adjustment of the net charge of molecules in a solution comprising adding one or more of the compositions of claim 1 to said solution.

24. The method of claim 23, for adjustment of the net charge of biomolecules, such as peptides, proteins, nucleic acids, cells or portions thereof, cell fragments, virus or portions thereof, viral particles, in order to reduce the need for dissolved buffer substances in a chromatographic method.
